(19) United States
(12) Patent Application Publication
(10) Pub. No.: US 2004/0168505 A1
(43) Pub. Date: Sep. 2, 2004

(54) Air conditioning system UV leak detection kit

(76) Inventor: Newton Howard Dudley, Blum, TX (US)

Correspondence Address: KONNEKER & SMITH P. C., 660 NORTH CENTRAL EXPRESSWAY, SUITE 230, PLANO, TX, 75074, US

(21) Appl. No.: 10/375,546

(22) Filed: Feb. 27, 2003

(51) Int. Cl. G01M 3/04

(52) U.S. Cl. 73/40.7

(57) ABSTRACT

An air conditioning system UV leak detection kit. In a described embodiment, an air conditioning system UV leak detection kit includes a hose having a connector at one end adapted to connect to the service port, and a valve at another end of the hose adapted to connect to a refrigerant can; a pressurized container containing UV dye, the valve being operably connectable to the container to dispense the UV dye from the container into the hose; a UV light source for illuminating the UV dye in the event that the UV dye escapes from the air conditioning system; and a light filtering device for enhancing viewing of the UV dye illuminated by the UV light source.

### BACKGROUND

The present invention relates generally to air conditioning system UV leak detection and, in an embodiment described herein, more particularly provides a UV leak detection kit.

When it is suspected that refrigerant may be leaking from an air conditioning system, a UV dye may be added to refrigerant in the system to aid in detecting the leak. The UV dye circulates through the system with the refrigerant. If the refrigerant leaks from the system, the UV dye will also be leaked. By detecting the presence of the UV dye, the location of the leak may be determined.

Unfortunately, this has been a cumbersome and inconvenient process in the past. A person desiring to use UV leak detection has been forced to separately obtain the UV dye, obtain some means for admitting the UV dye into the air conditioning system, obtain a UV light source for illuminating the UV dye and obtain a means for viewing the illuminated UV dye.

Therefore, it may be seen that an improved UV leak detection system is needed in the art.

### SUMMARY

In carrying out the principles of the present invention, in accordance with an embodiment thereof, an air conditioning system UV leak detection kit is provided which includes elements for introducing UV dye into the air conditioning system and detecting the presence of the UV dye at a location of a leak in the system.

In one aspect of the invention, a UV leak detection kit for an air conditioning system having a low pressure side service port is provided. The kit includes a hose having a connector at one end adapted to connect to the service port, and a valve at another end of the hose adapted to connect to a refrigerant can; a pressurized container containing R-134a refrigerant and UV dye, the valve being operably connectable to the container to dispense the refrigerant and UV dye from the container into the hose; a UV light source for illuminating the UV dye in the event that the UV dye escapes from the air conditioning system; and a light filtering device for enhancing viewing of the UV dye illuminated by the UV light source.

The connector on the hose is preferably a R-134a-type low pressure side service port quick connect connector. The valve and the container are threadedly connectable to each other to dispense the UV dye from the container, which preferably includes R-134a refrigerant therein.

The UV light source may be a battery powered handheld device. The light filtering device (glasses, goggles, etc.) filters out light having other than UV light spectrum wavelengths.

These and other features, advantages, benefits and objects of the present invention will become apparent to one of ordinary skill in the art upon careful consideration of the detailed description of a representative embodiment of the invention hereinbelow and the accompanying drawings.

### BRIEF DESCRIPTION OF THE DRAWINGS

FIG. 1 is a schematic view of a UV leak detection kit embodying principles of the present invention, the kit being used to detect the presence and location of a refrigerant leak in an air conditioning system.

### DETAILED DESCRIPTION

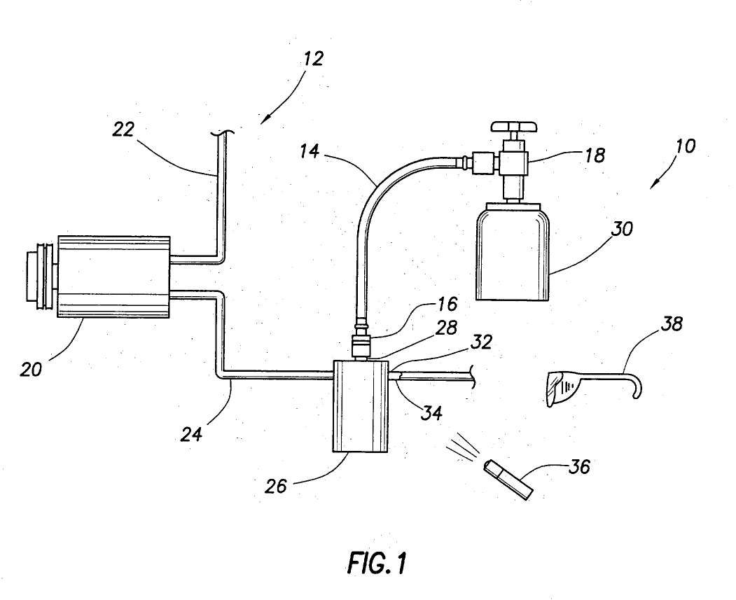

Representatively illustrated in FIG. 1 is an air conditioning system UV leak detection kit 10 which embodies principles of the present invention. In the following description of the kit 10 and other apparatus and methods described herein, directional terms, such as “above”, “below”, “upper”, “lower”, etc., are used only for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention.

As depicted in FIG. 1, the kit 10 is connected to an automotive air conditioning system 12. The air conditioning system 12 includes a compressor 20, a high pressure line 22 and a low pressure line 24. An accumulator 26 is interconnected in the low pressure line 24. The accumulator 26 has a service port 28 thereon for charging the system 12 with refrigerant. In some other systems, the service port 28 may be located in another portion of the low pressure line 24.

The kit 10 includes a hose 14 having a connector 16 at one end. The connector 16 is a conventional “quick connect” connector of the type used to connect to R-134a air conditioning system service ports. The quick connect connector 16 is not threaded to the service port 28, but is instead secured by manipulating an external sleeve to engage a series of balls with a recess on the service port.

At the other end of the hose 14 is a valve 18. The valve 18 is of the type which is threaded onto a R-134a-type refrigerant can for dispensing refrigerant from the can. Preferably, the quick connect connector 16 and the valve 18 are permanently attached to the ends of the hose 14, for example, using crimp sleeves.

R-134a refrigerant and UV dye is introduced into the air conditioning system 12 from a pressurized container 30. The refrigerant is preferably R-134a, but could be another refrigerant compatible with R-134a air conditioning systems, or another type of refrigerant or propellant. The valve 18 is threaded onto the container 30 and is used to dispense the UV dye and refrigerant from the container into the hose 14, and from the hose into the low side line 24 of the air conditioning system 12.

When there is a leak in the air conditioning system 12, for example, at a connection 32 between the low side line 24 and the accumulator 26, some of the UV dye 34 will escape along with the refrigerant. The UV dye 34 is detected by illuminating it with a UV light source 36. The light source 36 is preferably a battery-powered pen light.

Viewing of the illuminated UV dye 34 is enhanced by using a set of glasses, goggles or other light filtering device 38. The goggles 38 enhance the perceived brightness of the illuminated UV dye 34 by significantly filtering out light having wavelengths other than in the UV spectrum.

Thus, the UV leak detection kit 10 preferably includes the hose 14 (with connector 16 and valve 18 permanently attached), the container 30 of UV dye and refrigerant, the UV light source 36 and the goggles 38. These elements are packaged together and provided as a unit, so that a user obtains at one time all of the elements necessary to perform a UV leak detection. This is more convenient and less cumbersome for the user and, since each of the elements is selected and/or designed for use with the other elements of the kit 10, the user can be assured that each of the elements will perform as intended in conjunction with the other elements.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. A UV leak detection kit for an air conditioning system having a low pressure side service port, the kit comprising:
a hose having a connector at one end adapted to connect to the service port, and a valve at another end of the hose adapted to connect to a refrigerant can;
a pressurized container containing UV dye, the valve being operably connectable to the container to dispense the UV dye from the container into the hose;
a UV light source for illuminating the UV dye in the event that the UV dye escapes from the air conditioning system; and
a light filtering device for enhancing viewing of the UV dye illuminated by the UV light source.

2. The UV leak detection kit according to claim 1, wherein the connector on the hose is a quick connect connector.

3. The UV leak detection kit according to claim 1, wherein the connector on the hose is a R-134a-type low pressure side service port quick connect connector.

4. The UV leak detection kit according to claim 1, wherein the valve and the container are threadedly connectable to each other to dispense the UV dye from the container.

5. The UV leak detection kit according to claim 1, wherein the container further contains a refrigerant.

6. The UV leak detection kit according to claim 5, wherein the refrigerant is R-134a.

7. The UV leak detection kit according to claim 1, wherein the UV light source is battery powered.

8. The UV leak detection kit according to claim 1, wherein the light filtering device filters out light having other than UV light spectrum wavelengths.

9. The UV leak detection kit according to claim 1, wherein the valve is permanently attached to the hose.

10. The UV leak detection kit according to claim 1, wherein the connector is permanently attached to the hose.

11. A UV leak detection kit for an air conditioning system having a low pressure side service port, the kit comprising:
a hose having a R-134a-type low pressure side service port quick connect connector at one end adapted to connect to the service port, and a valve at another end of the hose adapted to connect to a refrigerant can;
a pressurized container containing UV dye and R-134a refrigerant, the valve being threadedly connectable to the container to dispense the UV dye and refrigerant from the container into the hose;
a battery powered UV light source for illuminating the UV dye in the event that the UV dye escapes from the air conditioning system; and
a light filtering device for enhancing viewing of the UV dye illuminated by the UV light source, the light filtering device filtering out light having other than UV light spectrum wavelengths.
